(19) United States
(12) Patent Application Publication
(10) Pub. No.: US 2024/0408769 A1
(43) Pub. Date: Dec. 12, 2024

(54) HOLDING DEVICE AND HOLDING METHOD

(71) Applicant: Panasonic Holdings Corporation, Osaka (JP)

(72) Inventors: YU KANEDA, Nara (JP); HIROKI IKEUCHI, Osaka (JP)

(21) Appl. No.: 18/808,044

(22) Filed: Aug. 18, 2024

Related U.S. Application Data
(63) Continuation of application No. PCT/JP2022/029994, filed on Aug. 4, 2022.

(30) Foreign Application Priority Data
Feb. 28, 2022 (JP) 2022-029907

(51) Int. Cl. B25J 15/00

(52) U.S. Cl. CPC B25J 15/0028

(57) ABSTRACT

A holding device includes: a spatula member having a front surface that is a surface that supports an object, a back surface, and a tip located between the front surface and the back surface; a mobile device that causes the tip to relatively approach the object; a belt having one end and another end and covering the front surface, the back surface, and the tip; a belt connection part connected to the one end; and a pulling member that is connected to the other end and pulls a portion of the belt covering the back surface in a direction away from the tip.

### TECHNICAL FIELD

The present disclosure relates to a holding device and a holding method.

### BACKGROUND ART

In various fields, automation of manufacturing processes is required. In order to automate a manufacturing process, a tool for holding an object, such as a part to be used in the manufacturing process, is required. Examples of such a tool are disclosed in PTL 1 and PTL 2.

PTL 1 discloses a transfer device including a transfer body, a support member, a transfer belt, a fixing mechanism, and an advancing and retracting mechanism. The transfer belt is fixed endlessly to the transfer body by the fixing mechanism. When the support member advances with respect to the transfer body, the transfer belt moves around the support member, and the object is placed on the support member via the transfer belt.

PTL 2 discloses a gripping device including a driving means, a base part, and a finger mechanism. The finger mechanism includes a driving wheel, a driven wheel, and an endless belt. When the object is sandwiched between a plurality of the finger mechanisms, the driving wheel rotates and the endless belt rotates, and the object is drawn between the plurality of the finger mechanisms.

### CITATION LIST

### Patent Literature

PTL 1: Japanese Patent No. 4941866
PTL 2: Unexamined Japanese Patent Publication No. 2016-030316

### SUMMARY OF THE INVENTION

Each of the tools disclosed in these literatures uses a belt. The tool using a belt cannot stably hold an object when the belt is slack.

A challenge of the present disclosure is to stably hold an object by a holding device.

A holding device according to the present disclosure includes: a spatula member having a front surface that is a surface that supports an object, a back surface, and a tip located between the front surface and the back surface; a mobile device that causes the tip to relatively approach the object; a belt having one end and another end and covering the front surface, the back surface, and the tip; a belt connection part connected to the one end; and a pulling member that is connected to the other end and pulls a portion of the belt covering the back surface in a direction away from the tip.

A holding device according to the present disclosure includes: a first spatula member having a first front surface that is a surface that supports an object, a first back surface, and a first tip located between the first front surface and the first back surface; a first belt having one end and another end and covering the first front surface, the first back surface, and the first tip; a first belt connection part connected to the one end of the first belt; a first pulling member that is connected to the other end of the first belt and pulls a portion of the first belt covering the first back surface in a direction away from the first tip; a second spatula member having a second front surface that is a surface that supports the object, a second back surface, and a second tip located between the second front surface and the second back surface; a second belt having one end and another end and covering the second front surface, the second back surface, and the second tip; a second belt connection part connected to the one end of the second belt; a second pulling member that is connected to the other end of the second belt and pulls a portion of the second belt covering the second back surface in a direction away from the second tip; and a mobile device that causes the first tip and the second tip to relatively approach the object.

A holding method according to the present disclosure includes: causing a spatula member having a front surface that is a surface that supports an object, a back surface, and a tip located between the front surface and the back surface to relatively approach the object; causing a belt having one end connected to a belt connection part and another end connected to a pulling member and covering the front surface, the back surface, and the tip to come into contact with the object; pulling, with the pulling member, a portion of the belt covering the back surface in a direction away from the tip; wrapping the portion of the belt covering the back surface around a side of the front surface; and supporting the object with the spatula member.

According to the present disclosure, an object can be stably held by the holding device.

### BRIEF DESCRIPTION OF THE DRAWINGS

FIG. 1 is a side view of a main part of a holding device according to a first exemplary embodiment.

FIG. 2 is a side view of the holding device according to the first exemplary embodiment in a use state.

FIG. 3 is a side view of the holding device according to the first exemplary embodiment in a use state.

FIG. 4 is a side view of a main part of a holding device according to a second exemplary embodiment.

FIG. 5 is a side view of a main part of a holding device according to a third exemplary embodiment.

FIG. 6 is a side view of a main part of a holding device according to a modification.

### DESCRIPTION OF EMBODIMENT

Hereinafter, exemplary embodiments of the present disclosure will be described with reference to the drawings. In the present description, an X axis is an axis extending in one horizontal direction, a Y axis is an axis extending vertically upward, and a Z axis is an axis constituting left-handed Cartesian coordinates together with the X axis and the Y axis. Also, in the present description, a front side or front is a positive side along the X axis or a direction having a positive component on the X axis, and a rear side or rear is a negative side along the X axis or a direction having a negative component on the X axis. Also, in the present description, an upper side or upward side is a positive side along the Y axis or a direction having a positive component on the Y axis, and a lower side or downward side is a negative side along the Y axis or a direction having a negative component on the Y axis. Also, in the present description, a left side or leftward side is a positive side along the Z axis or a direction having a positive component on the Z axis, and a right side or rightward side is a negative side along the Z axis or a direction having a negative component on the Z axis.

### First Exemplary Embodiment

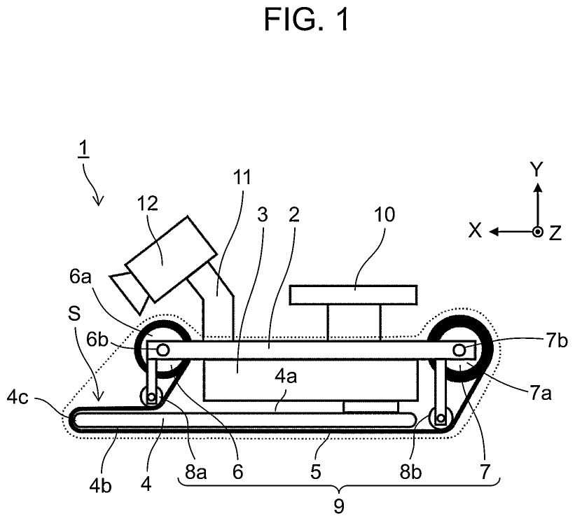

FIG. 1 is a side view of a main part of holding device 1 according to a first exemplary embodiment that is an aspect of the present disclosure. Holding device 1 includes base 2, linear motion device 3, spatula member 4, belt 5, belt connection part 6, pulling member 7, and guide rollers 8a, 8b. Belt 5, belt connection part 6, pulling member 7, and guide rollers 8a, 8b constitute belt unit 9. Belt unit 9 is surrounded by a broken line in FIG. 1. Holding device 1 includes robot arm attachment part 10, bracket 11, and object detection sensor 12.

Base 2 is a component constituting a body of holding device 1. Linear motion device 3 is attached to the lower side of base 2. Spatula member 4 is attached under linear motion device 3. That is, linear motion device 3 is arranged to be sandwiched between base 2 and spatula member 4. Note that holding device 1 may not include base 2. In this case, a portion of linear motion device 3 that moves relative to spatula member 4 can function as the body of holding device 1 instead of base 2.

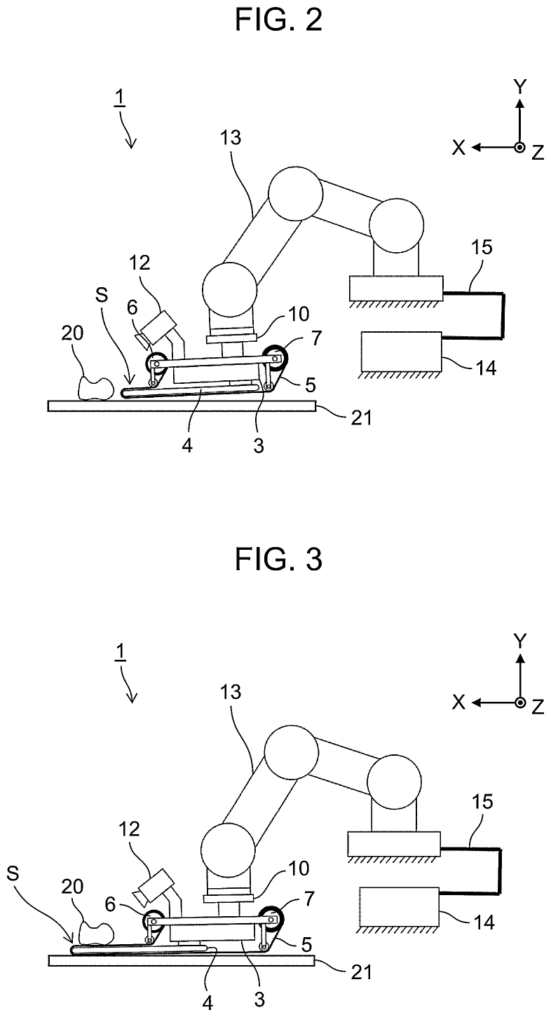

Spatula member 4 is a thin plate-shaped member having front surface 4a facing upward when holding device 1 holds object 20 (see FIG. 2), back surface 4b facing downward, and tip 4c located between front surface 4a and back surface 4b and serving as a boundary between front surface 4a and back surface 4b. Front surface 4a is a surface that supports object 20. Spatula member 4 is formed of a rigid body or an elastic body having sufficient rigidity to support object 20, for example, metal such as stainless steel, resin, or rubber. The thinner spatula member 4 is, the more easily it is inserted under object 20. In addition, although spatula member 4 is assumed to have sufficient rigidity, the more flexible spatula member 4 is, the more easily it is inserted under object 20 by being deformed along placement surface 21 (see FIG. 2) on which object 20 is placed.

Holding device 1 is disposed such that tip 4c is located on the front side (the positive side in the X axis direction). In other words, the Cartesian coordinate system is set such that, when spatula member 4 is brought into a horizontal state, a straight line connecting tip 4c and the other end of spatula member 4 becomes parallel to the X axis. Linear motion device 3 is operated by power of a motor or the like to linearly move spatula member 4 in the front-rear direction with respect to base 2. Linear motion device 3 constitutes, together with robot arm 13 to be described later, a mobile device that is a device for moving spatula member 4.

Belt 5 is a thin and flexible member longer than spatula member 4 and having substantially the same width as spatula member 4. Belt 5 covers front surface 4a, back surface 4b, and tip 4c. Belt 5 has one end and the other end. That is, belt 5 is not in an endless state with both ends connected. Therefore, belt 5 does not rotate around spatula member 4. However, belt 5 is configured to rotate around spatula member 4 in a pseudo manner. The one end of belt 5 is connected to belt connection part 6, and a portion on the one end side of belt 5 covers a portion on tip 4c side of front surface 4a. The other end of belt 5 is connected to pulling member 7, and a portion on the other end side of belt 5 covers the entire of back surface 4b. The portion, covering front surface 4a, of belt 5 constitutes support surface S that supports object 20. Belt 5 may be formed of a material, for example, PET or PTFE, that does not generate large friction among spatula member 4, object 20, and placement surface 21 when being inserted under object 20 and generates friction to such an extent that object 20 having been scooped does not slip.

Belt connection part 6 is attached to one end side (front side) of base 2. In the present exemplary embodiment, belt connection part 6 includes motor 6b and driving roller 6a configured to be rotatable in both forward and reverse directions by motor 6b. The one end of belt 5 is fixed to the peripheral surface of driving roller 6a. A part of belt 5 including the one end (a part on the one end side) is wound around the peripheral surface of driving roller 6a. Driving roller 6a is configured to be able to rotate forward to wind belt 5 and rotate backward to feed out belt 5.

Pulling member 7 is attached to the other end side (rear side) of base 2. In the present exemplary embodiment, pulling member 7 includes spring 7b and driven roller 7a to which a rotational force is applied by spring 7b. The other end of belt 5 is fixed to the peripheral surface of driven roller 7a. A part of belt 5 including the other end (a part on the other end side) is wound around the peripheral surface of driven roller 7a. The rotational force of spring 7b applies, to driven roller 7a, a rotational force in a positive direction that is a direction in which belt 5 is wound. Therefore, pulling member 7 always pulls the portion, covering back surface 4b, of belt 5 in a direction away from tip 4c, that is, toward the rear. When belt 5 is pulled forward by a force exceeding the rotational force of spring 7b, driven roller 7a rotates in the opposite direction to feed out belt 5. However, even during the feeding out, pulling member 7 always pulls belt 5 backward by the rotational force of spring 7b. Therefore, tension is always applied to a portion of belt 5 that is wound around neither driving roller 6a nor driven roller 7a (i.e., the portion covering front surface 4a, back surface 4b, and tip 4c). Therefore, belt 5 is always taut and is not slack.

Two guide rollers 8a, 8b are rotatably attached to base 2. Each of guide rollers 8a, 8b guides belt 5.

Guide roller 8a attached to the one end side (front side) of base 2 positions belt 5 such that, no matter where spatula member 4 is positioned with respect to base 2, the portion, covering front surface 4a, of belt 5 extends along front surface 4a between tip 4c and guide roller 8a. Belt 5 is disposed to pass through between front surface 4a and guide roller 8a.

Guide roller 8b attached to the other end side (rear side) of base 2 is disposed at a position where spatula member 4 and belt 5 can be prevented from coming into contact with each other to increase friction.

Robot arm attachment part 10 is attached to base 2.

Bracket 11 is attached to base 2, and object detection sensor 12 is attached to bracket 11. Object detection sensor 12 is a sensor for detecting object 20 (see FIG. 2) in front of holding device 1, placement surface 21 (see FIG. 2) on which object 20 is placed, and spatula member 4 covered with belt 5, and is, for example, a stereo camera or an infrared distance measuring sensor. Object detection sensor 12 may be attached to robot arm 13 to be described later.

FIG. 2 and FIG. 3 are side views of holding device 1 according to the first exemplary embodiment in a use state. In a use state, holding device 1 includes robot arm 13, controller 14, and cable 15. Robot arm 13 and controller 14 are connected via cable 15. Note that controller 14 may be directly attached to robot arm 13. In one example, controller 14 includes a memory and a processor that executes a program stored in the memory.

Robot arm 13 has a base end fixed to a stage or the like, and a tip connected to robot arm attachment part 10. Robot arm 13 can integrally move base 2 and each member attached to base 2 at least in the X axis positive direction and the X axis negative direction. In addition, robot arm 13 can integrally tilt base 2 and each member attached to base 2 at an arbitrary angle with respect to the horizontal plane, that is, the XZ plane. Therefore, robot arm 13 can move (i.e., advance) spatula member 4 in the X axis positive direction or move (i.e., retract) spatula member 4 in the X axis negative direction integrally with base 2 while keeping spatula member 4 tilted at an arbitrary angle with respect to the XZ plane. Robot arm 13 is, for example, a vertical articulated robot or a scalar robot.

Controller 14 supplies power to linear motion device 3, belt connection part 6, and robot arm 13 via cable 15, and controls linear motion device 3, belt connection part 6, and robot arm 13. In addition, controller 14 acquires a detection signal of object detection sensor 12.

### Operation Example 1

Holding device 1 configured as described above executes a holding method including the following respective operations to scoop and hold object 20. First, a case will be described, where object 20 is placed still on placement surface 21 that is stationary.

Controller 14 operates linear motion device 3 such that spatula member 4 is positioned at the rearmost end within the movement range of spatula member 4 with respect to base 2. Therefore, spatula member 4 is in the most retracted state relative to base 2. FIG. 2 illustrates this state.

Next, controller 14 operates robot arm 13 to integrally cause a member positioned ahead of robot arm 13 to move close to, that is, move forward to object 20 from the rear side.

Upon detecting object 20 that has entered a detection range, object detection sensor 12 transmits a detection signal to controller 14. Based on the detection signal from object detection sensor 12, controller 14 calculates, for example, the relative distance and the relative posture between object 20 and holding device 1 (in particular, spatula member 4), and an appropriate approach speed and a posture at the time of approach of holding device 1 (in particular, spatula member 4) with respect to object 20.

Controller 14 operates robot arm 13 to cause tip 4c of spatula member 4 to approach the boundary between object 20 and placement surface 21 at the appropriate speed calculated by controller 14 or set in advance. At this time, controller 14 operates robot arm 13 to set the posture of spatula member 4 to the appropriate posture calculated by controller device 14 or set in advance. The posture of spatula member 4 when approaching object 20 may be a posture in which spatula member 4, in particular, front surface 4a is as close to being parallel to placement surface 21 as possible within a range in which belt 5 does not come into contact with placement surface 21. Note that, when tip 4c approaches object 20, belt 5 may or may not come into contact with placement surface 21.

When tip 4c of spatula member 4 sufficiently approaches the boundary between object 20 and placement surface 21, controller 14 operates linear motion device 3 to move spatula member 4 forward. That is, linear motion device 3 inserts spatula member 4 between object 20 and placement surface 21. A state at this time is illustrated in FIG. 3.

When linear motion device 3 is operated to move spatula member 4 forward, the driving roller of belt connection part 6 may be fixed not to rotate. When spatula member 4 is moved forward by linear motion device 3, the portion, covering back surface 4b, of belt 5 wraps around tip 4c to create a state in which front surface 4a is covered. At this time, the driven roller of pulling member 7 rotates in reverse, and feeds out belt 5 forward while pulling belt 5 backward. During this time, tension is always applied to belt 5. Therefore, the portion of belt 5 to come into contact with object 20 moves, after coming into contact with object 20 and while being in contact with object 20 without being displaced with respect to object 20, that is, in a state in which the relative speed to object 20 is zero, so as to move in a sliding manner, together with object 20, on spatula member 4 from the front side to the rear side.

Until it is determined from the detection result of object detection sensor 12 that object 20 is completely placed on spatula member 4 via belt 5, that is, completely placed on support surface S, controller 14 operates linear motion device 3 to advance spatula member 4. Based on the detection result of object detection sensor 12, controller 14 may adjust an amount or speed by or at which spatula member 4 is advanced, and in some cases, may advance spatula member 4 again after once retracting spatula member 4.

If necessary, belt 5 may be wound by rotating the driving roller of belt connection part 6. By winding the belt with the driving roller, placing object 20 completely on support surface S (placing on the back side of support surface S) can be promoted. In a case where object 20 is one that is soft and easily deformed, the driving roller is rotated after object 20 leaves placement surface 21, whereby object 20 can be prevented from being deformed or torn when pulled between placement surface 21 and belt 5.

When it is determined from the detection result of object detection sensor 12 that object 20 is completely placed on support surface S, controller 14 stops the operation of linear motion device 3. When the driving roller of belt connection part 6 is being rotated, controller 14 also stops the operation of the motor of belt connection part 6. These complete a scooping operation for object 20.

Subsequently, an operation of carrying object 20 to a target position while holding it is performed. Controller 14 controls robot arm 13, so that spatula member 4 is moved toward the target position while front surface 4a of spatula member 4 is kept horizontal. At this time, the posture of spatula member 4 may be changed on the basis of the detection result from object detection sensor 12. That is, when object 20 slides or rolls on support surface S and is about to fall off from support surface S, the posture of spatula member 4 may be changed so that object 20 returns to the center of support surface S.

When object 20 slides or rolls on support surface S along the moving direction of belt 5, object 20 may be returned to the center of support surface S by rotating the driving roller of belt connection part 6 to feed out belt 5 from the driving roller or wind belt 5 around the driving roller. Since tension is applied to the belt by pulling member 7 even while belt 5 is fed out from the driving roller or wound around the driving roller, the belt does not become slack. Therefore, belt 5 can be moved densely, and object 20 can be reliably returned to the center of support surface S by the movement of belt 5. In addition, when the rotation of the driving roller starts, pulling member 7 functions as a shock absorber. That is, belt 5 reaches a steady speed after an acceleration period although it is a short time. Therefore, falling off of object 20 from support surface S, due to too large acceleration applied to object 20 when belt 5 suddenly moves at the steady speed, can be prevented. Note that the function of pulling member 7 as a shock absorber also functions effectively during the scooping operation.

When object 20 approaches the target position, each part operates in a reverse procedure to the procedure of the operation of scooping object 20 onto support surface S, whereby object 20 is placed on the target position.

In the case of the present operation example, spatula member 4, that does not directly come into contact with object 20 but substantially supports object 20 at a position very close to object 20, operates to scoop object 20. Therefore, object 20 can be scooped by finely and appropriately controlling the posture and the moving speed of spatula member 4 in accordance with the state of object 20 or the progress status of the scooping operation.

### Operation Example 2

Next, another example of the operation of scooping object 20 in the case where object 20 is placed still on placement surface 21 that is stationary will be described. The same operation as in Operation example 1 is performed until tip 4c of spatula member 4 is caused to approach the boundary between object 20 and placement surface 21. The operation after the scooping is the same as in Operation example 1.

When tip 4c of spatula member 4 sufficiently approaches the boundary between object 20 and placement surface 21 in the present operation example, controller 14 operates robot arm 13 to move spatula member 4 forward integrally with base 2 and the like. That is, robot arm 13, while in the state illustrated in FIG. 2, inserts spatula member 4 between object 20 and placement surface 21. At this time, controller 14 rotates the motor of belt connection part 6 such that the driving roller of belt connection part 6 winds belt 5. At this time, the moving speed of belt 5 is set such that a component in the X axis direction of the moving speed of belt 5 is equal to a component in the X axis direction of the moving speed of spatula member 4. That is, belt 5 seems, from object 20, not to be moving even though spatula member 4 is inserted into the boundary between object 20 and placement surface 21.

At this time, belt 5 is wound by the driving roller of belt connection part 6, and thus the portion, covering back surface 4b, of belt 5 wraps around tip 4c to cover front surface 4a. At this time, the driven roller of pulling member 7 rotates in reverse, and feeds out belt 5 forward while pulling belt 5 backward. During this time, tension is always applied to belt 5. Therefore, the portion of belt 5 to come into contact with object 20 moves, after coming into contact with object 20 and while being in contact with object 20 without being displaced with respect to object 20, that is, in a state in which the relative speed to object 20 is zero, so as to move in a sliding manner, together with object 20, on spatula member 4 from the front side to the rear side.

Until it is determined from the detection result of object detection sensor 12 that object 20 is completely placed on spatula member 4 via belt 5, that is, completely placed on support surface S, controller 14 operates the motor of belt connection part 6 to continue winding belt 5. When it is determined that object 20 is completely placed on support surface S, controller 14 stops the operation of the motor. These complete a scooping operation for object 20.

In the case of the present operation example, linear motion device 3 does not operate. That is, even in holding device 1 not including linear motion device 3, object 20 can be scooped by the present operation example. In other words, in the case of performing the present operation example, holding device 1 may include only robot arm 13 as the mobile device. Therefore, in the case of performing the present operation example, holding device 1 holding device 1 can be easily configured.

It is needless to say that spatula member 4 may advance by linear motion device 3 operating together with robot arm 13.

### Operation Example 3

Next, an operation example of scooping object 20 in a case where placement surface 21 is a surface of an object that moves, such as a belt conveyor, and object 20 is moving together with placement surface 21 will be described. Note that the operation example after the scooping is the same as in Operation example 1.

Controller 14 operates linear motion device 3 such that spatula member 4 is positioned at the rearmost end within the movement range of spatula member 4 with respect to base 2. Therefore, spatula member 4 is in the most retracted state relative to base 2.

Next, controller 14 operates robot arm 13 while using the detection result of object detection sensor 12, and causes a member (i.e., base 2 and the like) positioned ahead of robot arm 13 to integrally move close to, that is, advance to object 20 that is moving, from the rear side.

When determining from the detection result of object detection sensor 12 that the distance between tip 4c of the spatula member and object 20 is less than or equal to a predetermined value that has been set in advance, controller 14 operates robot arm 13 such that the relative positional relationship between tip 4c and object 20 does not change. In other words, by operating robot arm 13, controller 14 brings tip 4c into a state of being relatively stationary with respect to object 20 and placement surface 21 that are moving. This state of being relatively stationary may be continued for a certain period of time or for an extremely short period of time. For example, the state, in which tip 4c is relatively stationary with respect to object 20 and placement surface 21 that are moving, may be realized at a moment in a series of operations of holding device 1.

Note that, when the moving direction and moving speed of object 20 and placement surface 21 are known in advance, how to move robot arm 13 to bring them into a state of being relatively stationary may be taught in advance to controller 14. In addition, by performing feedback control of robot arm 13 on the basis of the detection result of object detection sensor 12, controller 14 may bring tip 4c into a state of being relatively stationary with respect to object 20 and placement surface 21.

Thereafter, by operating linear motion device 3 as in Operation example 1 while operating robot arm 13 such that at least base 2 is relatively stationary with respect to placement surface 21 that is moving, the object can be scooped on support surface S. Alternatively, by operating robot arm 13 so as to perform a movement that is sum of a movement in which at least base 2 is made relatively stationary with respect to placement surface 21 that is moving and a movement in which spatula member 4 is moved as in Operation example 2, the object can be scooped on support surface S.

Holding device 1 according to the present exemplary embodiment can bring spatula member 4 into a state of being substantially parallel to placement surface 21. Therefore, spatula member 4 can be more easily inserted between object 20 and placement surface 21, and after the insertion, object 20 can be more reliably prevented from rolling off or sliding off from on support surface S.

### Second Exemplary Embodiment

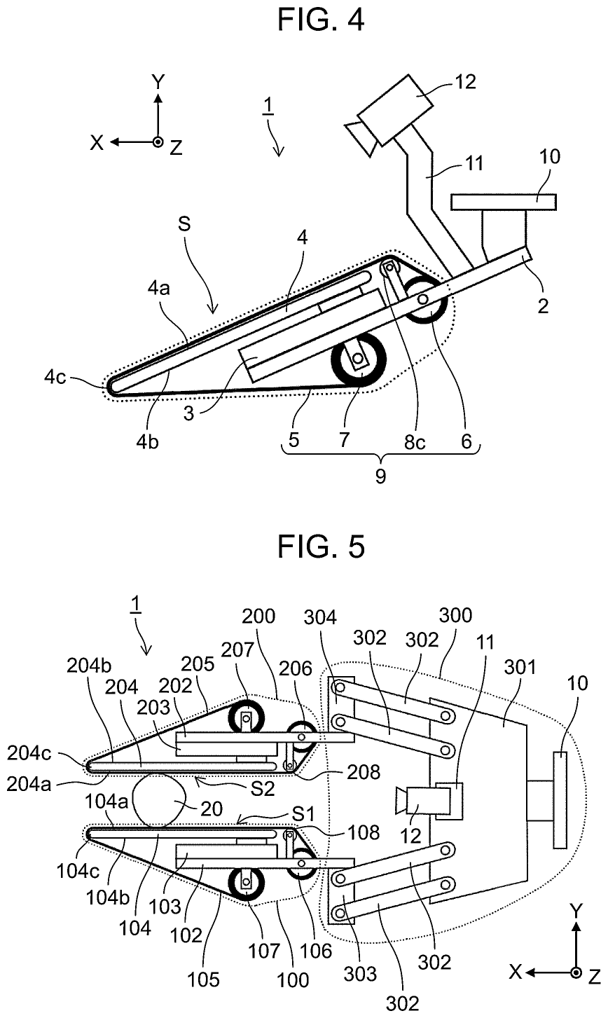

FIG. 4 is a side view of a main part of holding device 1 according to a second exemplary embodiment that is one aspect of the present disclosure. Holding device 1 includes base 2, linear motion device 3, spatula member 4, belt 5, belt connection part 6, pulling member 7, and guide roller 8c. Belt 5, belt connection part 6, pulling member 7, and guide roller 8c constitute belt unit 9. Belt unit 9 is surrounded by a broken line in FIG. 4. Holding device 1 includes robot arm attachment part 10, bracket 11, and object detection sensor 12.

Base 2 is a component constituting a body of holding device 1. Linear motion device 3 is attached to the upper side of base 2. Spatula member 4 is attached above linear motion device 3. Note that holding device 1 may not include base 2. In this case, a portion of linear motion device 3 that moves relative to spatula member 4 can function as the body of holding device 1.

Spatula member 4 is a thin plate-shaped member having front surface 4a facing upward when holding device 1 holds object 20 (see FIG. 2), back surface 4b facing downward, and tip 4c located between front surface 4a and back surface 4b and serving as a boundary between front surface 4a and back surface 4b. Front surface 4a is a surface that supports object 20. Spatula member 4 is formed of a rigid body or an elastic body having sufficient rigidity to support object 20, for example, metal such as stainless steel, resin, or rubber. The thinner spatula member 4 is, the more easily it is inserted under object 20. In addition, although spatula member 4 is assumed to have sufficient rigidity, the more flexible spatula member 4 is, the more easily it is inserted under object 20 by being deformed along placement surface 21 (see FIG. 2).

Holding device 1 is disposed such that tip 4c is located on the front side (the positive side in the X axis direction). In other words, the Cartesian coordinate system is set such that, when spatula member 4 is brought into a horizontal state, a straight line connecting tip 4c and the other end of spatula member 4 becomes parallel to the X axis. Linear motion device 3 is operated by power of a motor or the like to linearly move spatula member 4 in the front-rear direction with respect to base 2. Linear motion device 3 constitutes, together with robot arm 13 to be described later, a mobile device that is a device for moving spatula member 4.

Belt 5 is a thin and flexible member longer than spatula member 4 and having substantially the same width as spatula member 4. Belt 5 covers front surface 4a, back surface 4b, and tip 4c. Belt 5 has one end and the other end. That is, belt 5 is not in an endless state with both ends connected. Therefore, belt 5 does not rotate around spatula member 4. However, belt 5 is configured to rotate around spatula member 4 in a pseudo manner. One end of belt 5 is connected to belt connection part 6, and a portion on the one end side of belt 5 covers the entire of front surface 4a. The other end of belt 5 is connected to pulling member 7, and a portion on the other end side of belt 5 covers a portion on tip 4c side of back surface 4b. The portion, covering front surface 4a, of belt 5 constitutes support surface S that supports object 20. Belt 5 may be formed of a material, for example, PET or PTFE, that does not generate large friction among spatula member 4, object 20, and placement surface 21 when being inserted under object 20 and generates friction to such an extent that object 20 having been scooped does not slip.

Belt connection part 6 is disposed at a position (e.g., in the through hole of base 2) that is located on the rear side of linear motion device 3 and becomes lower than front surface 4a of spatula member 4 when holding device 1 supports object 20. Therefore, the entire of front surface 4a is covered with belt 5, and support surface S, that is wide because it is to be formed of the entire of front surface 4a, is eventually formed. In the present exemplary embodiment, belt connection part 6 includes a motor and a driving roller configured to be rotatable in both forward and reverse directions by the motor. The one end of belt 5 is fixed to the peripheral surface of the driving roller. A part of belt 5 including the one end (a part on the one end side) is wound around the peripheral surface of the driving roller. The driving roller is configured to be able to freely rotate forward to wind belt 5 and rotate backward to feed out belt 5.

Pulling member 7 is attached to the lower side of base 2. In the present exemplary embodiment, pulling member 7 includes a spring and a driven roller to which a rotational force is applied by the spring. The other end of belt 5 is fixed to the peripheral surface of the driven roller. A part of belt 5 including the other end (a part on the other end side) is wound around the peripheral surface of the driven roller. The rotational force of the spring applies, to the driven roller, a rotational force in a positive direction that is a direction in which belt 5 is wound. Therefore, pulling member 7 always pulls the portion, covering back surface 4b, of belt 5 in a direction away from tip 4c, that is, toward the rear. When belt 5 is pulled forward by a force exceeding the rotational force of the spring, the driven roller rotates in the opposite direction to feed out belt 5. However, even during the feeding out, pulling member 7 always pulls belt 5 backward by the rotational force of the spring. Therefore, tension is always applied to a portion of belt 5 that is wound around neither the driving roller nor the driven roller (i.e., a portion covering front surface 4a, back surface 4b, and tip 4c). Therefore, the belt is always taut and is not slack.

Note that the smaller the downward protrusion amount of pulling member 7 from base 2, and the closer the placement position is to the rear, the closer spatula member 4 can be brought to horizontal when object 20 (see FIG. 2) is scooped, whereby object 20 can be easily scooped. On the other hand, the smaller the downward protrusion amount of pulling member 7 from base 2, and the closer the placement position is to the rear, the more easily belt 5 comes into contact with base 2. Therefore, pulling member 7 is disposed such that, within a range in which belt 5 does not come into contact with base 2, the downward protrusion amount from base 2 is as small as possible and the pulling member 7 is positioned as close to the rear as possible.

Guide roller 8c is rotatably attached to base 2. Guide roller 8c guides belt 5. Guide roller 8c is disposed at a position where the friction, due to the contact between spatula member 4 and belt 5, can be prevented from increasing.

Robot arm attachment part 10 is attached to base 2.

Bracket 11 is attached to base 2, and object detection sensor 12 is attached to bracket 11. Object detection sensor 12 is a sensor for detecting object 20 (see FIG. 2) in front of holding device 1, placement surface 21 (see FIG. 2) on which object 20 is placed, and spatula member 4 covered with belt 5, and is, for example, a stereo camera or an infrared distance measuring sensor.

Similarly to holding device 1 according to the first exemplary embodiment, holding device 1 according to the present exemplary embodiment is also connected to robot arm 13 and connected to controller 14 via cable 15. Robot arm 13 is configured similarly in the first exemplary embodiment.

### Operation Example 4

Holding device 1 configured as described above scoops and holds, with the following operation, object 20 placed still on placement surface 21 that is stationary. Hereinafter, description of matters common in Operation example 1 will be omitted.

Controller 14 operates robot arm 13 to cause tip 4c of spatula member 4 to approach the boundary between object 20 and placement surface 21 at the appropriate speed calculated by controller 14 or set in advance.

When tip 4c of spatula member 4 sufficiently approaches the boundary between object 20 and placement surface 21, controller 14 operates linear motion device 3 to move spatula member 4 forward. That is, linear motion device 3 inserts spatula member 4 between object 20 and placement surface 21.

Controller 14 controls linear motion device 3 and robot arm 13 such that tip 4c of spatula member 4 advances along placement surface 21. At this time, tip 4c may advance while being in contact with placement surface 21 via belt 5, and in this case, the force with which tip 4c pushes placement surface 21 may be maintained in an appropriate predetermined range that has been set in advance. If the force with which tip 4c pushes placement surface 21 is too large, the friction between belt 5 and placement surface 21 increases, and thus tip 4c of spatula member cannot be smoothly advanced. Conversely, if the force with which tip 4c pushes placement surface 21 is too small, tip 4c easily lifts up from placement surface 21, and thus spatula member 4 can fail to be inserted between object 20 and placement surface 21. That is, by maintaining the force with which tip 4c pushes placement surface 21 within an appropriate predetermined range that has been set in advance, object 20 can be smoothly and reliably scooped. The force with which tip 4c pushes placement surface 21 can be adjusted by adjusting the power to be supplied to the motor included in linear motion device 3 or robot arm 13.

Spatula member 4 may be elastically deformed by maintaining the force with which tip 4c pushes placement surface 21 within an appropriate predetermined range that has been set in advance. In other words, spatula member 4 may be curved by pressing tip 4c of spatula member 4 against placement surface 21. When spatula member 4 is curved, the portion on tip 4c side has a shape along placement surface 21. Therefore, object 20 can be scooped more easily.

When holding device 1 scoops object 20 and object 20 is placed on support surface S, robot arm 13 operates such that spatula member 4 becomes horizontal. Thereafter, object 20 is conveyed toward the target position similarly in Operation example 1, and object 20 is removed from holding device 1.

Although detailed description is omitted for the sake of repetition, holding device 1 according to the second exemplary embodiment can also scoop object 20 while operating robot arm 13 and without operating linear motion device 3, similarly to holding device 1 according to the first exemplary embodiment. Similarly to holding device 1 according to the first exemplary embodiment, holding device 1 according to the second exemplary embodiment can also scoop object 20 by operating both robot arm 13 and linear motion device 3. Similarly to holding device 1 according to the first exemplary embodiment, holding device 1 according to the second exemplary embodiment can also scoop object 20 that is moving and placed on placement surface 21 that is moving.

Holding device 1 according to the present exemplary embodiment has support surface S that is larger. Therefore, object 20 that is larger can be held.

### Third Exemplary Embodiment

FIG. 5 is a side view of a main part of holding device 1 according to a third exemplary embodiment that is one aspect of the present disclosure. Holding device 1 according to the present exemplary embodiment includes first unit 100 and second unit 200 that are configured similarly to the main part of holding device 1 according to the second exemplary embodiment. In addition, holding device 1 according to the present exemplary embodiment includes opening and closing unit 300 connected to first unit 100 and second unit 200.

First unit 100 includes first base 102, first linear motion device 103, first spatula member 104, first belt 105, first belt connection part 106, first pulling member 107, and first guide roller 108. These members are configured similarly to base 2, linear motion device 3, spatula member 4, belt 5, belt connection part 6, pulling member 7, and guide roller 8c in holding device 1 according to the second exemplary embodiment.

Second unit 200 includes second base 202, second linear motion device 203, second spatula member 204, second belt 205, second belt connection part 206, second pulling member 207, and second guide roller 208. These members are configured similarly to base 2, linear motion device 3, spatula member 4, belt 5, belt connection part 6, pulling member 7, and guide roller 8c in holding device 1 according to the second exemplary embodiment.

Opening and closing unit 300 includes common base 301, a plurality of links 302, first link connection part 303, second link connection part 304, robot arm attachment part 10, bracket 11, and object detection sensor 12.

First link connection part 303 and second link connection part 304 are fixed to first base 102 and second base 202, respectively. First link connection part 303 and second link connection part 304 are connected to common base 301 via the plurality of links 302 constituting a parallel link mechanism. Common base 301 or first link connection part 303 and second link connection part 304 includes or include motors that move first base 102 and second base 202 with respect to common base 301 via the parallel link mechanisms.

Robot arm attachment part 10 is fixed to common base 301. Bracket 11 is attached to common base 301. Object detection sensor 12 is attached to bracket 11 so as to face forward and toward the space between first unit 100 and second unit 200.

First spatula member 104 is a thin plate-shaped member having first front surface 104a facing upward when holding device 1 holds object 20, first back surface 104b facing downward, and first tip 104c located between first front surface 104a and first back surface 104b and serving as a boundary between first front surface 104a and first back surface 104b. First front surface 104a is a surface that supports object 20. A portion, covering first front surface 104a, of first belt 105 constitutes first support surface S1 that supports object 20.

Second spatula member 204 is a thin plate-shaped member having second front surface 204a facing downward when holding device 1 holds object 20, second back surface 204b facing upward, and second tip 204c located between second front surface 204a and second back surface 204b and serving as a boundary between second front surface 204a and second back surface 204b. Second front surface 204a is a surface that supports object 20. A portion, covering second front surface 204a, of second belt 205 constitutes second support surface S2 that supports object 20.

First unit 100 and second unit 200 are arranged such that first front surface 104a and second front surface 204a are parallel to each other and face each other via first belt 105 and second belt 205.

Similarly to holding devices 1 according to the first exemplary embodiment and the second exemplary embodiment, holding device 1 according to the present exemplary embodiment is also connected to robot arm 13 and connected to controller 14 via cable 15. Robot arm 13 is configured similarly in the first exemplary embodiment.

### Operation Example 5

Holding device 1 configured as described above scoops, grips, and holds, with the following operation, object 20 placed still on placement surface 21 that is stationary.

First, the distance between first unit 100 and second unit 200, specifically, the distance between first support surface S1 and second support surface S2, is set to a predetermined size set in advance on the basis of the size of object 20. Controller 14 adjusts the distance by operating the motor that moves the parallel link mechanism. The distance between first unit 100 and second unit 200 may be set on the basis of the size of object 20 detected by object detection sensor 12.

Subsequently, controller 14 causes first unit 100 to perform the same operation as when holding device 1 according to the second exemplary embodiment scoops object 20.

When it is determined from the detection result of object detection sensor 12 that the scooping of object 20 by first unit 100 has been completed, controller 14 operates second linear motion device 203 to move second spatula member 204 by the same length as the distance by which first spatula member 104 has been moved during the scooping operation. The movement of second spatula member 204 may be performed simultaneously with the movement of first spatula member 104.

Subsequently, controller 14 operates the motor that moves the parallel link mechanism to bring second unit 200 close to first unit 100. Controller 14 brings second unit 200 closer to first unit 100 until it is determined based on the detection result of object detection sensor 12 that second support surface S2 has come into contact with object 20.

When second support surface S2 comes into contact with object 20, gripping of object 20 by first unit 100 and second unit 200 is realized. There is no other member between first support surface S1 and second support surface S2. Therefore, there is no lower limit on the size of object 20 that can be gripped. That is, holding device 1 according to the present exemplary embodiment can grip object 20 that is small.

After object 20 is gripped, controller 14 may rotate the motor of first belt connection part 106 and the motor of second belt connection part 206 to wind first belt 105 and second belt 205 by the driving roller of first belt connection part 106 and the driving roller of second belt connection part 206. By winding each of the belts as described above, object 20 can be drawn to the rear side while being gripped, and can be held more reliably.

In addition, before each belt is wound, after it is wound, or while it is being wounded, controller 14 may operate robot arm 13 to level first support surface S1 and second support surface S2. By leveling each support surface, object 20 can be more reliably prevented from falling from between first support surface S1 and second support surface S2.

In addition, by integrally rotating the front member of robot arm attachment part 10 about the X axis while object 20 is being gripped, the posture of object 20 can be changed. That is, holding device 1 according to the present exemplary embodiment can place object 20 at the target position in a posture different from that when it is scooped. For example, after a cylindrical member in a lying state is scooped, the cylindrical member can be placed in an upright state.

### Operation Example 6

In addition, holding device 1 according to the third exemplary embodiment can grip and extract object 20, which is a target, without damaging object 20 from a plurality of objects 20 placed densely.

When such an operation is performed, controller 14 first causes, based on the detection result of object detection sensor 12, first unit 100 and second unit 200 to approach object 20, which is a target, from above while adjusting the distance between first unit 100 and second unit 200.

Subsequently, the parallel link mechanism is operated until object 20, which is a target, is gripped between first support surface S1 and second support surface S2.

When it is confirmed that object 20, which is a target, is gripped, controller 14 operates the driving roller of first belt connection part 106 and the driving roller of second belt connection part 206 to wind first belt 105 and second belt 205. As a result, object 20, which is a target, can be moved without being damaged between first support surface S1 and second support surface S2 so as to suck up object 20, which is a target.

By operating as described above, holding device 1 can grip and extract object 20, which is a target, without damaging object 20 from the plurality of objects 20 placed densely.

In the present operation example, an example, in which holding device 1 is brought close to object 20 from above, has been shown, but the present disclosure is not limited thereto. For example, when holding device 1 is obliquely brought close to object 20 that has been grounded, object 20 can be scooped by using first unit 100 and then gripped. In addition, for example, in a case where a plurality of objects 20 are densely placed on a plane, object 20, which is a target, can be gripped even if holding device 1 is brought close from the side. As described above, the approaching direction of holding device 1 can be appropriately changed depending on the placement state of the plurality of objects 20 (e.g., the direction in which they are lined up) and the shape thereof.

In addition, when object 20 is scooped or extracted, belt 5 and spatula member 4 may move integrally by belt connection part 6 and pulling member 7 feeding out or winding belt 5. That is, belt 5 and spatula member 4 may be moved such that the relative speed between belt 5 and spatula member 4 becomes zero at least at tip 4c. For example, in a case where object 20 is heavy, a large gripping force is required, and on the other hand, if belt 5 is to be moved relative to spatula member 4, the frictional force between belt 5 and front surface 4a of spatula member 4 increases immediately under object 20. If the frictional force becomes too large, it becomes difficult to move belt 5 with respect to spatula member 4, and it can be difficult to scoop and extract object 20. However, by integrally moving belt 5 and spatula member 4, object 20 can be reliably held even if object 20 is heavy. For example, by integrally retracting belt 5 and spatula member 4, object 20 can be drawn toward robot arm 13. At this time, the driving roller may be stopped or rotated at the time of approaching such that the relative speed between belt 5 and object 20 becomes zero to bring spatula member 4 close to object 20, and after the gripping, the driving roller and linear motion device 3 may be controlled such that the relative speed between belt 5 and spatula member 4 becomes zero to grip and extract the object 20.

According to holding device 1 of the present disclosure, friction does not occur between object 20 and belt 5. In addition, even in a case where there are a plurality of belts, friction does not occur between the respective belts (first belt 105 and second belt 205). Therefore, not only a rigid body but also even a soft object or a gel-like object can be scooped, transported, and placed without being broken. That is, holding device 1 according to the present disclosure can stably hold an object.

### Modifications

The present disclosure is not limited to the exemplary embodiments described so far, and includes various modifications without departing from the gist of the present disclosure.

For example, before object 20 comes into contact with belt 5, the driving roller of belt connection part 6 may wind or feed out belt 5 such that the center, in the longitudinal direction, of belt 5 is located at a position where the center comes into contact with tip 4c of spatula member 4. By aligning the center, in the longitudinal direction, of belt 5 with tip 4c of spatula member 4, a sufficient margin can be secured in any case of moving belt 5. In other words, the lengths of the winding allowance and feeding-out allowance by the driving roller of belt connection part 6 can be made sufficient.

When Operation example 2 is performed, the driving roller of belt connection part 6 may not operate. Therefore, in this case, belt connection part 6 may not include the driving roller and the motor and be a fixing member that fixes one end of belt 5 so as not to move relative to base 2.

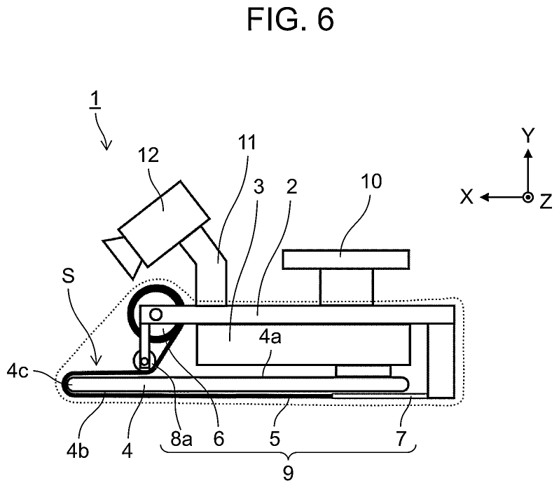

Instead of the spring, pulling member 7 may include another elastic body, for example, rubber. Since pulling member 7 includes the driven roller, there is an advantage that a longer feeding-out allowance can be secured. However, when a long feeding-out allowance is unnecessary, any configuration may be adopted as long as the portion, covering back surface 4b of spatula member 4, of belt 5 can be moved in the front-rear direction while being pulled in the direction away from tip 4c. For example, pulling member 7 may be an elastic body (e.g., a coil spring or a rubber string) having one end fixed to the other end of belt 5 and the other end fixed to base 2 that is L-shaped and extending linearly, as illustrated in FIG. 6.

A plurality of sets of belt units 9 may be arranged side by side in the Z axis direction such that the respective sets are configured to operate independently of each other. By operating the respective sets independently of each other after object 20 is scooped, object 20 can be rotated about the Y axis or moved in the X axis direction while being rotated about the Y axis. Based on the detection result of object detection sensor 12, controller 14 may control the moving speed and moving direction of belt 5 of each set. It is needless to say that, in each of first unit 100 and second unit 200 of holding device 1 according to the third exemplary embodiment, a plurality of belt units 9 may be arranged side by side in the Z axis direction.

In addition, holding device 1 may include a fall prevention plate that prevents object 20 that has been scooped from falling. The fall prevention plate may include a pair of plate members that sandwich spatula member 4 from the left and right and prevent object 20 on support surface S from falling left or right. In the case of the second exemplary embodiment, the fall prevention plate may include a plate member that is disposed near the rear end of spatula member 4 and prevents the object on support surface S from falling backward.

In the case of the first exemplary embodiment, holding device 1 may include a guard plate that prevents object 20 that has been scooped from being caught between belt 5 and guide roller 8a. In the case of including the guard plate, holding device 1 may take a posture in which, when object 20 is transported, the tip side of support surface S is slightly raised.

In a case where placement surface 21 on which object 20 is placed and the target position constitute a moving stage, holding device 1 may not move. That is, holding device 1 may not include robot arm 13 in this case. In other words, the mobile device may be only linear motion device 3.

Holding device 1 according to the third exemplary embodiment may include first unit 100 and second unit 200 that are configured similarly to the main part of holding device 1 according to the first exemplary embodiment. In addition, holding device 1 according to the third exemplary embodiment may further include, in addition to first unit 100 and second unit 200, one or more units configured similarly to these units.

### INDUSTRIAL APPLICABILITY

The present disclosure can be used in devices for realizing automation of manufacturing processes in various fields.

### REFERENCE MARKS IN THE DRAWINGS

1 holding device
2 base
3 linear motion device
4 spatula member
4a front surface
4b back surface
4c tip
5 belt
6 belt connection part
6a driving roller
6b motor
7 pulling member
7a driven roller
7b spring
8a, 8b, 8c guide roller
9 belt unit
10 robot arm attachment part
11 bracket
12 object detection sensor
13 robot arm
14 controller
15 cable
20 object
21 placement surface
100 first unit
102 first base
103 first linear motion device
104 first spatula member
104a first front surface
104b first back surface
104c first tip
105 first belt
106 first belt connection part
107 first pulling member
108 first guide roller
200 second unit
202 second base
203 second linear motion device
204 second spatula member
204a second front surface
204b second back surface
204c second tip
205 second belt
206 second belt connection part
207 second pulling member
208 second guide roller
300 opening and closing unit
301 common base
302 link
303 first link connection part
304 second link connection part
S support surface
S1 first support surface
S2 second support surface

1. A holding device comprising:
a spatula member having a front surface that is a surface that supports an object, a back surface, and a tip located between the front surface and the back surface;
a mobile device that causes the tip to relatively approach the object;
a belt having one end and another end and covering the front surface, the back surface, and the tip;
a belt connection part connected to the one end; and
a pulling member that is connected to the other end and pulls a portion of the belt covering the back surface in a direction away from the tip.

2. The holding device according to claim 1, wherein the pulling member includes a driven roller around which a part of the belt including the other end is wound to be freely wound and fed out.

3. The holding device according to claim 2, wherein the pulling member further includes a spring that applies a rotational force to the driven roller.

4. The holding device according to claim 1, wherein the mobile device includes a linear motion device that moves the spatula member with respect to the belt connection part.

5. The holding device according to claim 1, wherein the mobile device includes a robot arm that integrally moves the spatula member, the belt, the belt connection part, and the pulling member.

6. The holding device according to claim 1, wherein the belt connection part includes a driving roller around which the part of the belt including the one end is wound to be freely wound and fed out, and a motor that rotates the driving roller.

7. The holding device according to claim 1, wherein the pulling device is configured in which, after the object comes into contact with the belt, a relative speed of a portion of the belt, that is in contact with the object, to the object becomes zero.

8. The holding device according to claim 1, further comprising:
an object detection sensor that detects a position of the object; and
a controller that controls at least one of the mobile device and the belt connection part based on a detection result of the object detection sensor.

9. A holding device comprising:
a first spatula member having a first front surface that is a surface that supports an object, a first back surface, and a first tip located between the first front surface and the first back surface;
a first belt having one end and another end and covering the first front surface, the first back surface, and the first tip;
a first belt connection part connected to the one end of the first belt;
a first pulling member that is connected to the other end of the first belt and pulls a portion of the first belt covering the first back surface in a direction away from the first tip;
a second spatula member having a second front surface that is a surface that supports the object, a second back surface, and a second tip located between the second front surface and the second back surface;
a second belt having one end and another end and covering the second front surface, the second back surface, and the second tip;
a second belt connection part connected to the one end of the second belt;
a second pulling member that is connected to the other end of the second belt and pulls a portion of the second belt covering the second back surface in a direction away from the second tip; and
a mobile device that causes the first tip and the second tip to relatively approach the object.

10. A holding method comprising:
causing a spatula member having a front surface that is a surface that supports an object, a back surface, and a tip located between the front surface and the back surface to relatively approach the object;
causing a belt having one end connected to a belt connection part and another end connected to a pulling member and covering the front surface, the back surface, and the tip to come into contact with the object;
pulling, with the pulling member, a portion of the belt covering the back surface in a direction away from the tip;
wrapping the portion of the belt covering the back surface around a position covering the front surface; and
supporting the object with the spatula member.
